(19) United States
(12) Patent Application Publication
(10) Pub. No.: US 2026/0099527 A1
(43) Pub. Date: Apr. 9, 2026

(54) System-Specific and Query-Specific Expert Large Language Model

(71) Applicant: Dell Products L.P., Round Rock, TX (US)

(72) Inventors: Shoham Levy, Pardes Hana – Karkur (IL); Osnat Shasha, Holon (IL); Alex Kulakovsky, Ra'anana (IL); Rivka Matosevich, Zichron Ya'acov (IL)

(21) Appl. No.: 18/909,875

(22) Filed: Oct. 8, 2024

(51) Int. Cl. G06F 16/33; G06F 16/383

(52) U.S. Cl. CPC G06F 16/3344; G06F 16/3347; G06F 16/383

(57) ABSTRACT

A system can input a first context to a large language model (LLM) to produce a first output, wherein the first context comprises a description of a computing system and a prompt to summarize it, and wherein the first output comprises the summary. The system can identify examples stored in a database based on a vectorization of an input document and a query. The system can input a second context to the LLM to produce a second output, wherein the second context comprises the summary, at least some of the examples, the input document, and the query, and wherein the second output comprises a response. The system can input a third context to the LLM to produce a third output, wherein the third context comprises the summary, the at least some of the examples, the second output, and first user input data indicative of a refinement query.

### BACKGROUND

A large language model (LLM) can generally comprise a form of a neural network that is configured to generate a natural language output that is responsive to a natural language input.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can input a first context to a large language model to produce a first output, wherein the first context comprises a description of a first computing system other than the system and a prompt to summarize the description, and wherein the first output comprises a summary of the first computing system. The system can identify examples from a group of examples stored in a database based on a vectorization of an input document and a query, wherein respective examples of the group of examples identify respective input queries and respective answers corresponding to the respective input queries, and wherein at least one example of the group of examples relates to a second computing system other than the first computing system or the system. The system can input a second context to the large language model to produce a second output, wherein the second context comprises the summary of the first computing system, at least some of the examples, the input document, and the query, and wherein the second output comprises a response corresponding to the second context. The system can input a third context to the large language model to produce a third output, wherein the third context comprises the summary of the first computing system, the at least some of the examples, the second output, and first user input data indicative of a refinement query. The system can update a process applicable to the identifying of the examples from the database based on second user input data indicative of a grade of a quality of the third output.

An example method can comprise inputting, by a system comprising at least one processor, a first context to a large language model to produce a first output, wherein the first context comprises a description of computer equipment, and wherein the first output comprises a summary of the computer equipment. The method can further comprise identifying, by the system, examples from a group of examples stored in a database based on an input document and a query, wherein respective examples of the group of examples identify respective input queries and respective answers corresponding to the respective input queries. The method can further comprise inputting, by the system, a second context to the large language model to produce a second output, wherein the second context comprises the summary, at least two of the examples, the input document, and the query. The method can further comprise inputting, by the system, a third context to the large language model to produce a third output, wherein the third context comprises the summary, the at least two of the examples, the second output, and first user input data indicative of a refinement query. The method can further comprise updating, by the system, a process of the identifying of the examples from the database based on second user input data indicative of a grade of a quality of the third output.

An example non-transitory computer-readable medium can comprise instructions that, in response to execution, cause a system comprising a processor to perform operations. These operations can comprise inputting a first context to a large language model to obtain a first output, wherein the first context comprises a description of a second computer system, and wherein the first output comprises a summary of the second computer system. These operations can further comprise identifying examples from a group of examples stored via a database based on an input document and a query, wherein respective examples of the group of examples identify respective input queries and corresponding respective answers. These operations can further comprise inputting a second context to the large language model to obtain a second output, wherein the second context comprises the summary, at least some of the examples, the input document, and the query. These operations can further comprise updating a process used for the identifying of the examples from the database based on user input data indicative of a grade of a quality of the second output.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate a system-specific and query-specific expert LLM, in accordance with an embodiment of this disclosure;

FIG. 2 illustrates an example of an entry in a question-and-answer (Q&A) database that can facilitate a system-specific and query-specific expert LLM, in accordance with an embodiment of this disclosure;

FIG. 3 illustrates an example system architecture of a domain/system summary, and that can facilitate a system-specific and query-specific expert LLM, in accordance with an embodiment of this disclosure;

FIG. 4 illustrates an example system architecture of running a query, and that can facilitate a system-specific and query-specific expert LLM, in accordance with an embodiment of this disclosure;

FIG. 5 illustrates an example system architecture for multiple users, and that can facilitate a system-specific and query-specific expert LLM, in accordance with an embodiment of this disclosure;

FIG. 6 illustrates an example process flow that can facilitate a system-specific and query-specific expert LLM, in accordance with an embodiment of this disclosure;

FIG. 7 illustrates another example process flow that can facilitate a system-specific and query-specific expert LLM, in accordance with an embodiment of this disclosure;

FIG. 8 illustrates another example process flow that can facilitate a system-specific and query-specific expert LLM, in accordance with an embodiment of this disclosure;

FIG. 9 illustrates another example process flow that can facilitate a system-specific and query-specific expert LLM, in accordance with an embodiment of this disclosure;

FIG. 10 illustrates another example process flow that can facilitate a system-specific and query-specific expert LLM, in accordance with an embodiment of this disclosure; and

FIG. 11 illustrates an example block diagram of a computer operable to execute an embodiment of this disclosure.

### DETAILED DESCRIPTION

### Overview

Fine tuning a large language model (LLM) (large language model) can be an expensive and time-consuming task. Doing so can require many thousands, or even millions, of labeled inputs to teach a new system to the LLM—so that the system can be properly analyzed. In some examples, it can be that this is not possible because there are not that many inputs available. However, it is possible to use the LLM context (that is, the prompt) to provide some examples of input and required outputs—using few-shot learning—to obtain suitable results.

The present techniques can generally comprise a generic approach to creating a system that comprises an LLM that has the expertise of an analyzed system, for a certain types of queries on that analyzed system, for cases where there are not enough relevant system-specific examples to fine-tune the LLM. This can be done by creating a prompt prefix that contains system-specific context and a curated array of input-query-and-answer examples. This prompt prefix can be inserted to each new query's prompt before the requested query and input document. The system can help build this prompt prefix, use it, and refine it, as users add new generated content to the system.

As used herein, a “domain” can refer to the system being analyzed, so as to differentiate it from a system built around an LLM as described herein.

A use case for the proposed system can be an LLM used to answer similar questions on a specific domain. For instance, for a group of security engineers analyzing design documents of a big software (SW) and hardware (HW) system—trying to find security breaches:
The domain is the system being analyzed. That is, what it does, which components it comprises, etc.
The query can relate to system vulnerabilities.
The input can comprise documents describing part or parts of the system in more detail, or different system use cases.
The expected answer format can be component vulnerability reports and use cases.

Another example can comprise a group of accountants performing audits for a company:
The domain is the company being audited. That is, its structure and relations.
The query can be about illegal, or misaligned operations.
The input can be a collection of tax documents, income documents, expense reports, etc.
The expected answer format can be reports that show the trail of money and suspicious operations.

An LLM context can be limited in size, so it can be that the information fed into it must be concise and accurate. The context size can be measured in tokens, which represent words (such as 4 letters, on average ¾ of a word). So, a system according to the present techniques can generate a customized and concise prompt prefix for every query.

The present techniques can be implemented to define a system that can provide high quality answers, using a specific format, to similar queries on a specific domain, on different inputs. A domain can comprise the system or field of knowledge on which the LLM is expected to provide answers.

A query can comprise a transformation instruction, that is, the execution command for the LLM. For example a query can be to summarize the security aspects defined in a document in the form of a list of tasks. Another example of a query can be to write Haiku songs describing the main characteristics of each person mentioned in a provided story.

A format can comprise a way the answer should be formatted. For example, code in a specific programming language, an essay, a table of data, a list of tasks, a Haiku song, or an International Standards Organization 9000 (ISO9000) document.

In some examples, fine-tuning the LLM for expected answer formats can be performed. For example, where there are many examples of the required answer format, even if not for the same kind of queries and on different domains, it can be possible to train the LLM model on that type of format. This can help the LLM produce answers using the correct format.

In scenarios where the format is specific and complex, for example ISO9000, it can be useful to train the LLM in advance. This can be the case where it is not possible to fit the entire format definition in the prompt's prefix due to space constraints.

In some examples of the present techniques, the following can be implemented. The system summary can be created as a vector DB, and not as plain document to be added to the input context. Vector DBs can be fed to the LLM, rather than as part of the context. This way, the LLM can ingest the (vector DB) system summary without reducing the available context size for user inputs and example documents.

Grading the generated answer can be performed on multiple vectors, such as, accuracy, level of details, and overall quality. Then a user can choose both the grade of each potential example over word matching, and also the weight for each of its grades. For instance, to answer a complex question, it could be that an answer with a higher level of detail could be better than one with better grammar. Or, in the case of formulas, it can be that a more accurate example is better than a more wholistic or detailed answer.

The present techniques can facilitate a system that automatically builds a finely-tuned LLM context, the prompt prefix, and that improves the answers for a specific type of question on a domain that the LLM does not possess prior knowledge of. The present techniques can also facilitate a system that continuously combines new products from multiple (user) sessions, to constantly improve its answers. The present techniques can also facilitate an autogenerated LLM context that can include the best and most useful (or sufficiently good) history for a defined question, from user sessions.

The present techniques can facilitate using one LLM (or instances of one LLM) and enabling a multi-user system where different users can query the LLM regarding different domains (e.g., the different users'different computer systems). In this manner, costly training and/or tuning of an LLM to be domain specific can be avoided.

Prior approaches can involve prompt programming and building a context with relevant examples. In prior approaches, it can be left to the LLM user to build the context prefix (examples and prompt) for their queries—few shots. It can be that there is no system that takes advantage of the fact multiple users are repeatedly running similar queries and can share context and use a feedback loop to constantly improve the answers.

In the case of prior approaches to interactive LLM sessions, the context can be based on the chat history. It can be that the prior approaches do not automatically pull in relevant data, and are not able to be tuned for a single query type, nor to a single domain. It can be that prior approaches do not take advantage of multiple, similar (in domain and query) sessions carried out by other users in parallel.

### Example Architectures, Tables, and Flows

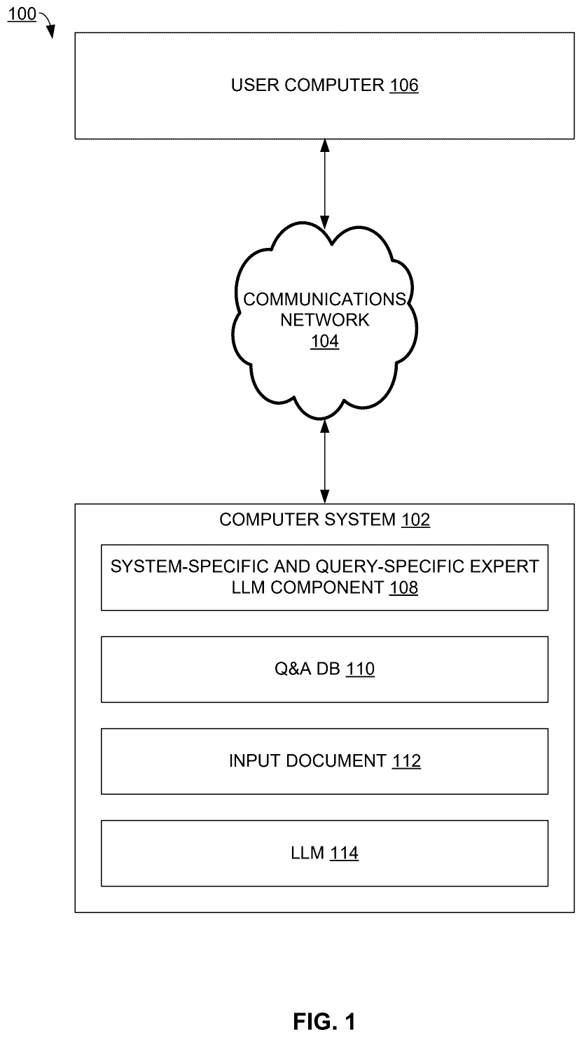

FIG. 1 illustrates an example system architecture 100 that can facilitate a system-specific and query-specific expert LLM, in accordance with an embodiment of this disclosure.

System architecture 100 comprises computer system 102, communications network 104, and user computer 106. In turn, computer system 102 comprises system-specific and query-specific expert LLM component 108, Q&A DB 110, input document 112, and LLM 114.

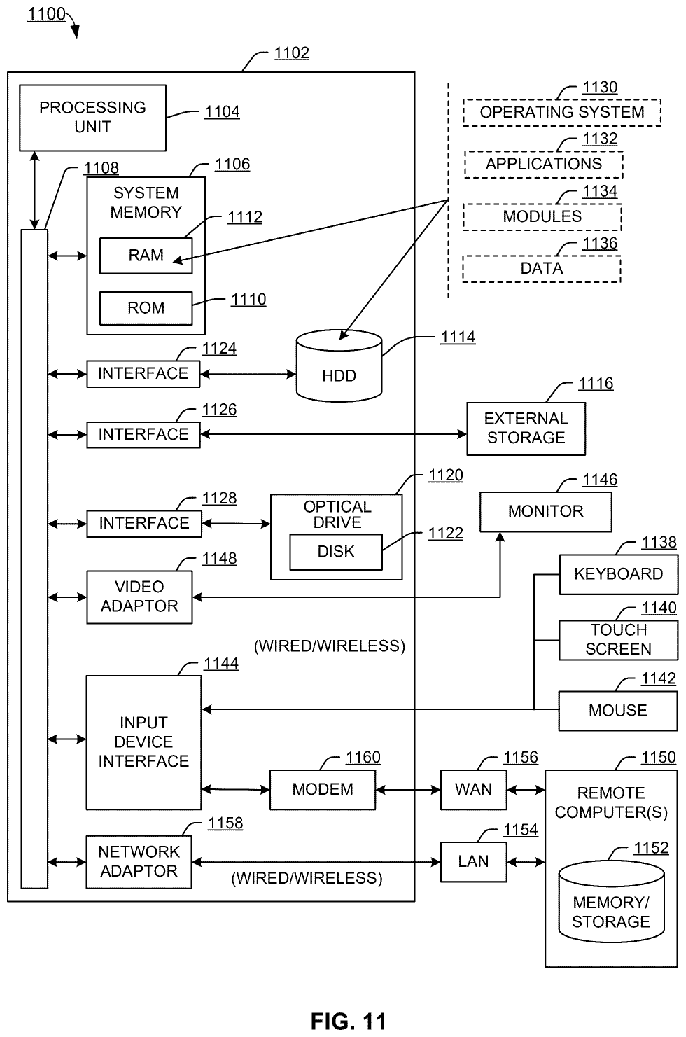

Each of computer system 102 and/or user computer 106 can be implemented with part(s) of computing environment 1100 of FIG. 11. Communications network 104 can comprise a computer communications network, such as the Internet, or an isolated private computer communications network.

System-specific and query-specific expert LLM component 108 can receive a query from user computer 106 about a particular computer system, along with input document 112. System-specific and query-specific expert LLM component 108 can utilize the query, input document 112, and information from Q&A DB 110 to prompt LLM 114, which can generate an output that comprises an answer to the query.

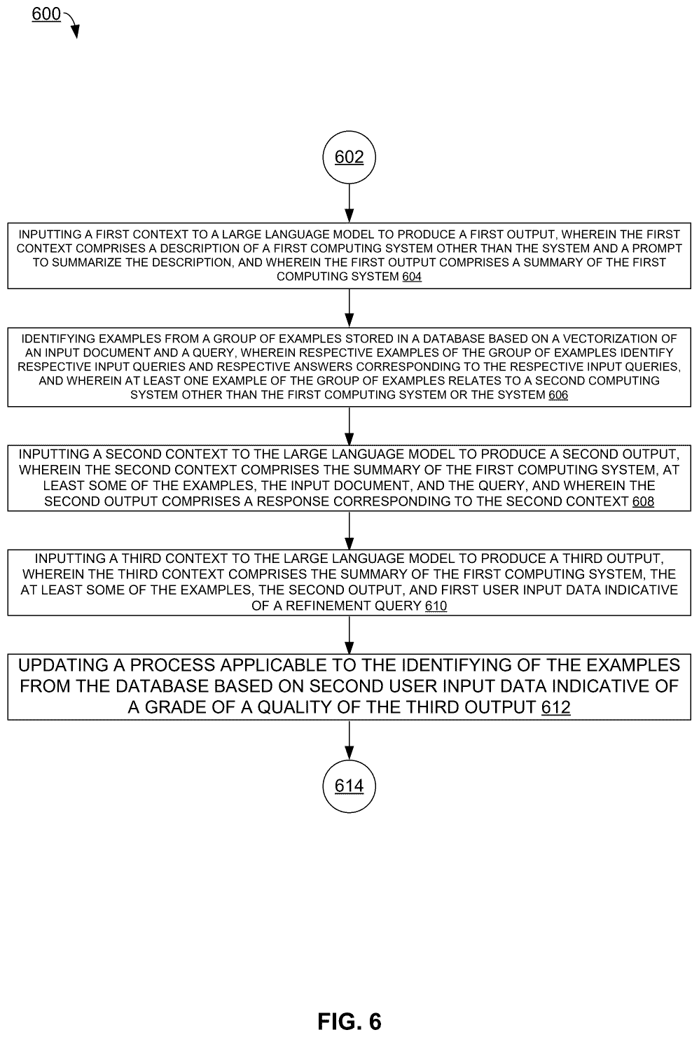

In some examples, system-specific and query-specific expert LLM component 108 can implement part(s) of the process flows of FIGS. 6-10 to facilitate a system-specific and query-specific expert LLM.

It can be appreciated that system architecture 100 is one example system architecture for a system-specific and query-specific expert LLM, and that there can be other system architectures that facilitate a system-specific and query-specific expert LLM.

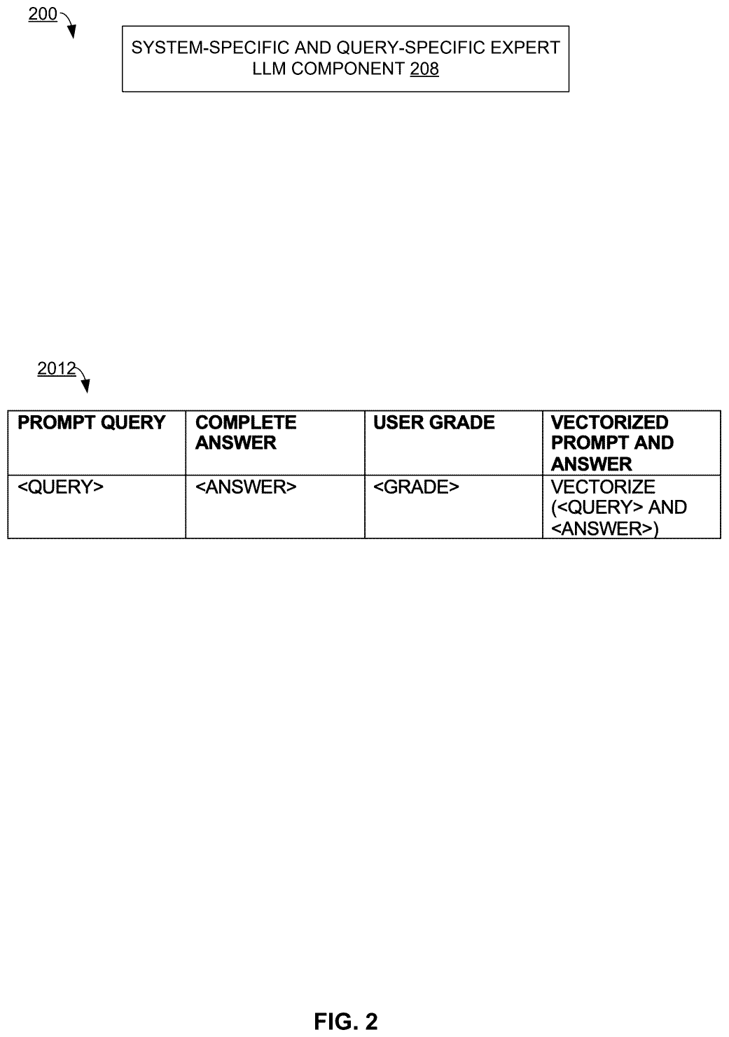

FIG. 2 illustrates an example 200 of an entry in a question-and-answer (Q&A) database that can facilitate a system-specific and query-specific expert LLM, in accordance with an embodiment of this disclosure. In some examples, part(s) of example 200 can be implemented by part(s) of system architecture 100 to facilitate a system-specific and query-specific expert LLM.

Example 200 comprises entry 202 and system-specific and query-specific expert LLM component 208 (which can be similar to system-specific and query-specific expert LLM component 108 of FIG. 1).

In some examples, the present techniques can incorporate a question-and-answer (Q&A) database that comprises previous examples for previous queries on the domain, and corresponding properly-formatted answers that were returned. This database can be used to fetch examples for the prompt prefix. In some examples, it can comprise:
1. The prompt query and document input. In some examples, this can be stored without the prefix (a system description and prior examples).
2. The answer for the query and document input.
3. A user-provided grade for the answer. The grade can represent the quality of the example. For instance: 1 being a low quality, and 10 being an excellent answer. This can be a subjective metric that can be used to help prioritize the examples used in building the prompt prefix.
4. Vectorized keywords of the query, input, and answer. This can help search for relevant examples when building the prompt prefix. The keywords can come from the domain summary part of the prefix, and from general keyword lists. In some examples, different types of text vectorization can be implemented, such as a binary term frequency or bag of words (BoW) term frequency. In some examples, this can generally be referred to as natural language processing (NLP).

In some examples, a user can initially fill in and grade some number of examples in the DB. As it can be a domain with a small number of examples, it can be expected to be a concise list. During the system's work, each new answer—which is accepted—can be stored in the DB after being graded by the user. This way, the examples DB can grow and improve the generated prompt prefix as it is used over time.

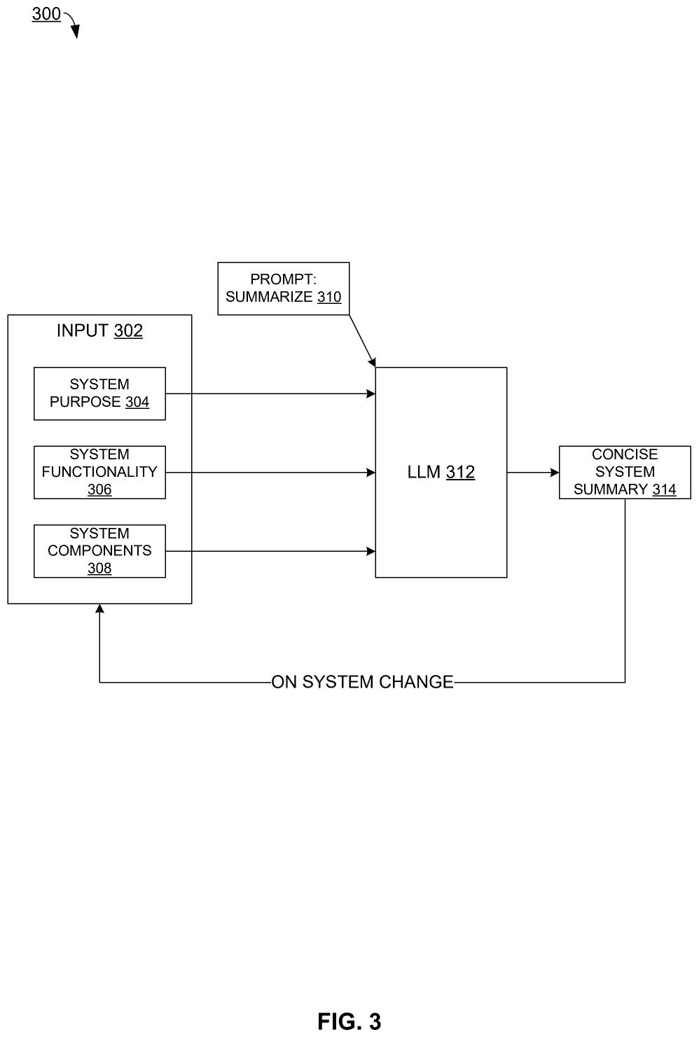

FIG. 3 illustrates an example system architecture 300 of a domain/system summary, and that can facilitate a system-specific and query-specific expert LLM, in accordance with an embodiment of this disclosure. In some examples, part(s) of system architecture 300 can be implemented by part(s) of system architecture 100 to facilitate a system-specific and query-specific expert LLM.

System architecture 300 comprises input 302, prompt: summarize 310, LLM 312, and concise system summary 314. In turn, input 302 comprises system purpose 304, system functionality 306, and system components 308.

In some examples, the present techniques can be implemented with a five-step process.

A first step of the example five step process comprises creating a summary of the domain can be implemented as follows. The summary can be generated once, using the LLM, before users start working with a domain-specific-system. It can be then used for subsequent queries, by all users. When the domain changes, a new summary can be generated to incorporate the new and modified components and behaviors. An example prompt for summary creation can be, “Summarize the system defined in the following document. Make sure to include the system input and desired output, different components and their relations, and related terminology.”

A system according to the present techniques can receive an input document, or several documents, describing the domain. It can define a purpose or main functionality of the system. It can include a list of system components, their connections, and interactions. Using an LLM, the input can be summarized so that it can fit in a prefix.

In some examples, the level of detail in the input documents for the summary can depend on the level of details required for proper understanding of queried documents. That is, the level of detail can define high-level characteristics of the domain, assuming the later queried documents will provide finer details for relevant parts of the system. The documents can provide the domain-context, so that it can be clear what the system can be expected to do or describe, and the main concepts are present.

A second step of the example five step process comprises selecting relevant query-answer examples for the prefix. A user can provide an input document and the query. The system can vectorize the input query and document, extracting keywords and key context.

Using the vectorized keywords in the Q&A examples DB, a system according to the present techniques can grade the most relevant examples against the extracted document and query keywords and context. The system can also weigh each example's grade. Depending on the desired level of details, and system complexity, the user can fine-tune the system to give more, or less weight to the quality of the answer over the closeness in concepts/context to the input document and input query.

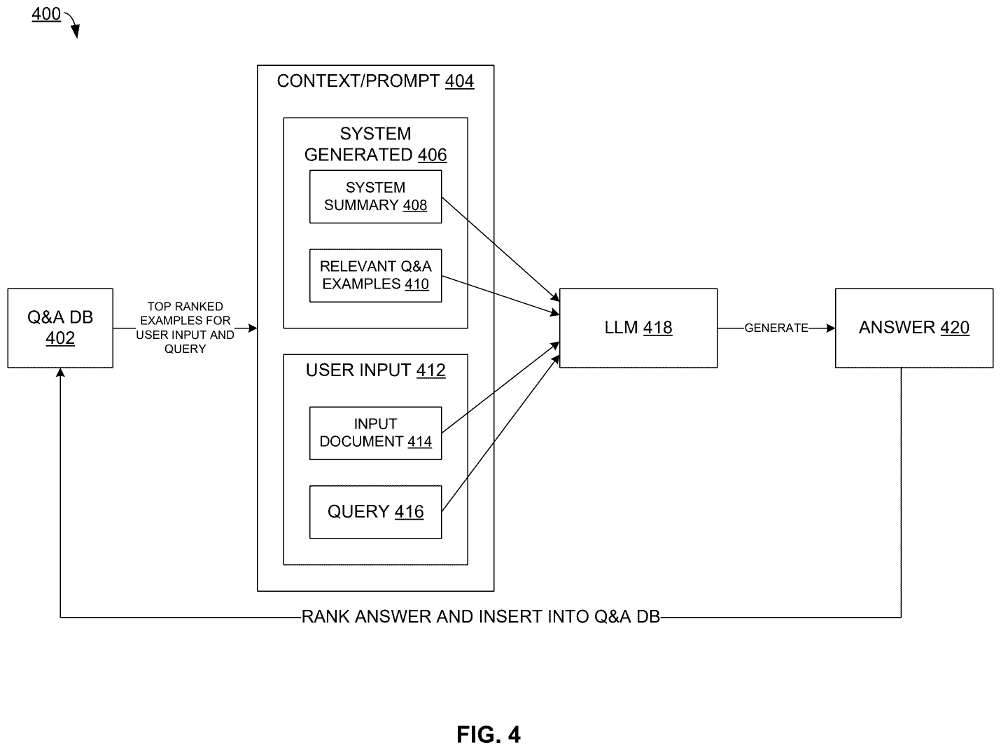

FIG. 4 illustrates an example system architecture 400 of running a query, and that can facilitate a system-specific and query-specific expert LLM, in accordance with an embodiment of this disclosure. In some examples, part(s) of system architecture 400 can be implemented by part(s) of system architecture 100 to facilitate a system-specific and query-specific expert LLM.

System architecture 400 comprises Q&A DB 402, context/prompt 404, LLM 418, and answer 420. In turn, context/prompt 404 comprises system generated 406 (itself comprising system summary 408 and relevant Q&A examples 410) and user input 412 (itself comprising input document 414 and query 416).

A third step of the example five step process comprises querying the input document. A system according to the present techniques can assemble the context of the query:
1. Summary: The pre-determined summary.
2. Examples: The top ranked examples found in the previous stage. In some examples, this can comprise as many examples as the context can hold, together with the input document and the summary. As the context gets bigger, it can become easier to provide more examples in the context and the ranking (of examples) can become less critical for the end-result.
3. The input document.
4. the Query.

A fourth step of the example five step process comprises refining the answer.

In this step, the user can now interact with the system (LLM), to refine the provided answer. The user can be interacting with a simple prompt, where she writes her refinement queries. For each iteration, the system can build the following context and append to the user's refinement query:
1. Summary: The pre-calculated summary.
2. Examples: The top ranked examples found in the previous stage. This can comprise as many examples as the context can hold together with the input document and the summary.
3. The last generated document can be the new input.
4. The user's refinement query. This can help shape the new answer.

A fifth step of the example five step process comprises enhancing the context examples and adding answers to the DB. Once the user is happy with the answer, she can be prompted to grade it. The grade can be subjective, on a uniform scale (e.g., 1 to 10), and can be used together with the vectorized texts to choose examples for further system invocations. Low-grade answers can indicate to the system to ignore this document and never use it as an example.

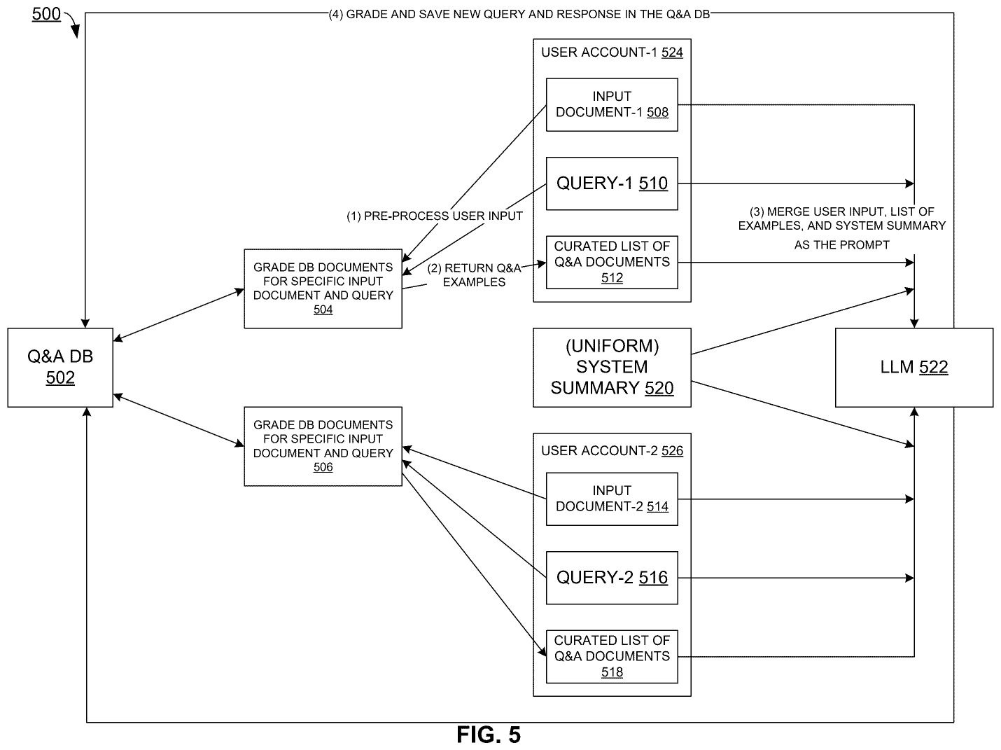

FIG. 5 illustrates an example system architecture 500 for multiple users, and that can facilitate a system-specific and query-specific expert LLM, in accordance with an embodiment of this disclosure. In some examples, part(s) of system architecture 500 can be implemented by part(s) of system architecture 100 to facilitate a system-specific and query-specific expert LLM.

System architecture 500 comprises Q&A DB 502, grade DB documents for specific input document and query 504, grade DB documents for specific input document and query 506, input document-1 508, query-1 510, curated list of Q&A documents 512, input document-2 514, query-2 516, curated list of Q&A documents 518, (uniform) system summary 520, LLM 522, user account-1 524, and user account-2 526.

As illustrated in system architecture 500, one LLM (e.g., LLM 522) can be used to process queries from multiple users (e.g., user account-1 524 and user account-2 526) about different systems without that LLM being tuned to generate those answers.

### Example Process Flows

FIG. 6 illustrates an example process flow 600 that can facilitate a system-specific and query-specific expert LLM, in accordance with an embodiment of this disclosure. In some examples, part(s) of process flow 600 can be implemented by part(s) of system architecture 100 to facilitate a system-specific and query-specific expert LLM. In some examples, one or more embodiments of process flow 600 can be implemented by system architecture 100, or computing environment 1100 of FIG. 11.

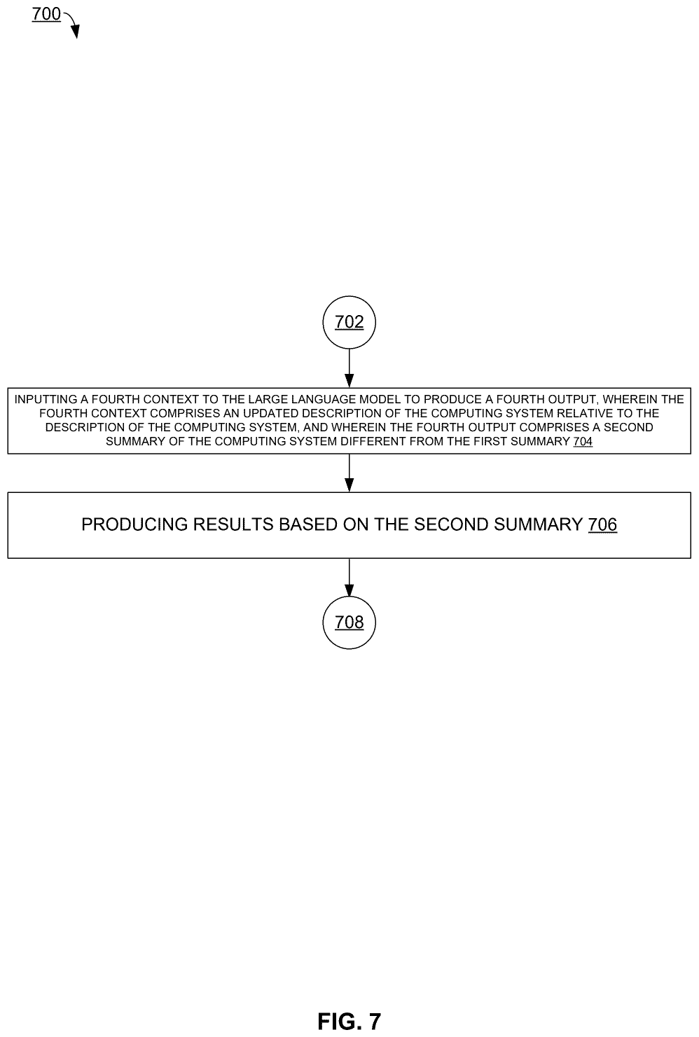

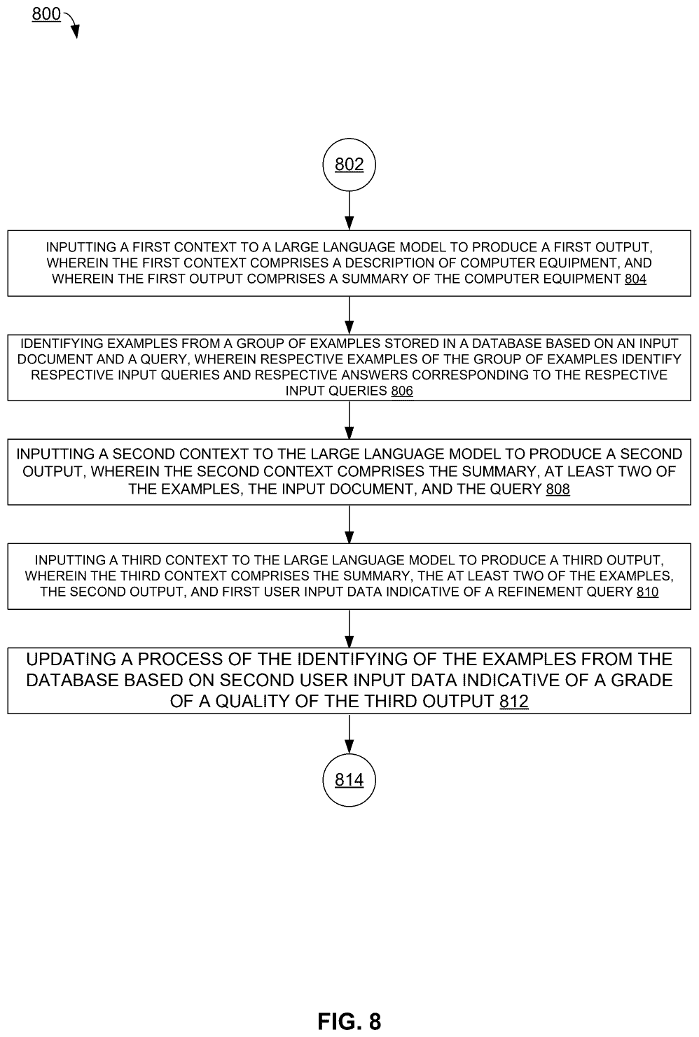

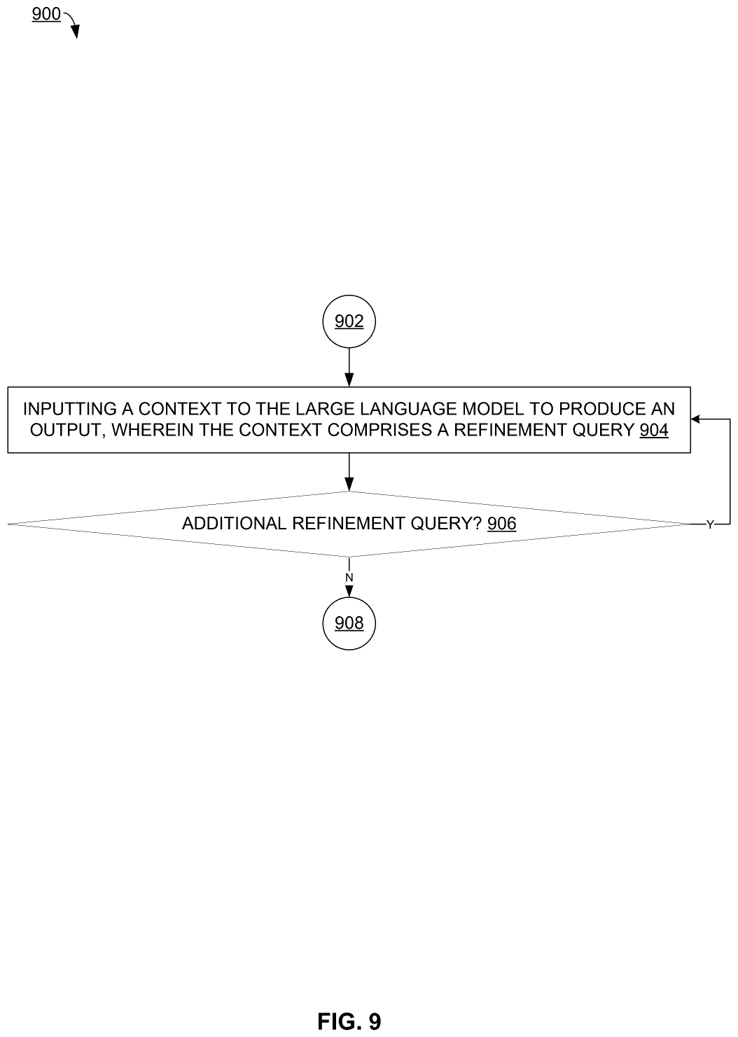

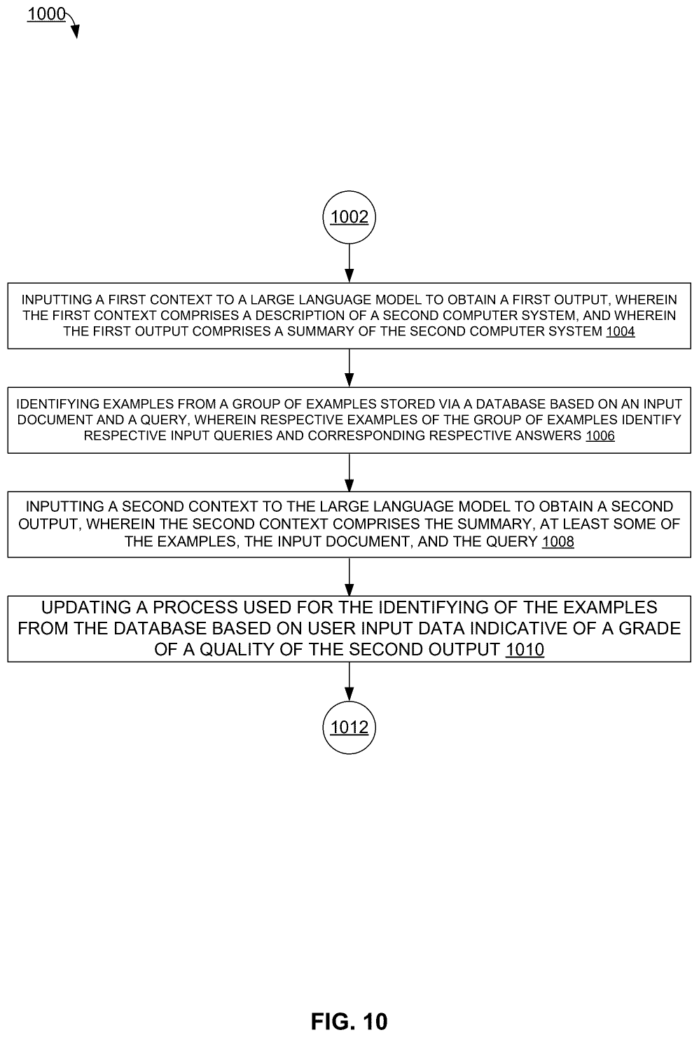

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of process flow 700 of FIG. 7, process flow 800 of FIG. 8, process flow 900 of FIG. 9, and/or process flow 1000 of FIG. 10.

Process flow 600 begins with 602, and moves to operation 604.

Operation 604 depicts inputting a first context to a large language model to produce a first output, wherein the first context comprises a description of a first computing system other than the system and a prompt to summarize the description, and wherein the first output comprises a summary of the first computing system. This can comprise step 1 (creating a summary of the domain) as described herein. This can be performed periodically, such as when the computer system changes.

In some lengths, a first character length of the summary of the first computing system is shorter than a second character length of the description of the first computing system. That is, the summary of the first computing system description can be shorter than the first computing system description itself.

In some examples, a character length of the summary of the first computing system is based on a maximum character length of a prefix to the large language model. That is, a description can be shortened into a summary so that it fits into a maximum length of a prefix to an LLM.

In some examples, the description of the first computing system comprises a first identification of a purpose of the first computing system, a second identification of a first functionality of the first computing system, or a third identification of a second functionality of components of the first computing system. This can be similar to input 302 of FIG. 3.

After operation 604, process flow 600 moves to operation 606.

Operation 606 depicts identifying examples from a group of examples stored in a database based on a vectorization of an input document and a query, wherein respective examples of the group of examples identify respective input queries and respective answers corresponding to the respective input queries. This can comprise step 2 (selecting relevant query-answer examples for the prefix) as described herein. That is, this can involve analyzing or vectorizing the new question, and selecting relevant Q&As from the database.

The input document can comprise a system description, and can be made up of generic, relatively static, documents about the system. In contrast to that, the DB can hold past queries and their answers, rather than input documents. The DB can be updated after operation 612, where a user can grade the new Q&A, and it is pushed into the DB.

In some examples, the vectorization of the input document and the query is performed based on a binary term frequency process or a bag of words term frequency process.

In some examples, the respective examples comprise respective scores, the respective scores indicate respective quality of the respective answers, and the identifying of the examples is performed based on the respective scores. In some examples, the respective examples comprise respective scores, the identifying of the examples is performed based on third user input data, and the third user input data is indicative of a weighting of answer quality relative to concept closeness.

That is, using the vectorized keywords in the Q&A examples DB, a system according to the present techniques can grade the most relevant examples against the extracted document and query keywords and context. The system can also weigh each example's grade. Depending on the desired level of details, and system complexity, the user can fine-tune the system to give more, or less weight to the quality of the answer over the closeness in concepts/context to the input document and input query.

After operation 606, process flow 600 moves to operation 608.

Operation 608 depicts inputting a second context to the large language model to produce a second output, wherein the second context comprises the summary of the first computing system, at least some of the examples, the input document, and the query, and wherein the second output comprises a response corresponding to the second context. This can comprise step 3 (querying the input document) as described herein. Here, a context can be built from a summary, the selected Q&As, and the new question, and a new answer from the LLM can be obtained.

After operation 608, process flow 600 moves to operation 610.

Operation 610 depicts inputting a third context to the large language model to produce a third output, wherein the third context comprises the summary of the first computing system, the at least some of the examples, the second output, and first user input data indicative of a refinement query. This can comprise step 4 (refining the answer) as described herein. That is, a back-and-forth with the user can occur to refine the new answer.

After operation 610, process flow 600 moves to operation 612.

Operation 612 depicts updating a process applicable to the identifying of the examples from the database based on second user input data indicative of a grade of a quality of the third output. this can comprise step 5 (adding the new question and the new answer to the DB, with a grade to the answer; so, additional queries have even more Q&As to choose from). In some examples, all (or multiple) users of the system can contribute to the Q&A DB. So, the system can combine work of multiple users of the system, thus improving the quality of the context (that is, chosen Q&As) dynamically.

After operation 612, process flow 600 moves to 614, where process flow 600 ends.

FIG. 7 illustrates another example process flow 700 that can facilitate a system-specific and query-specific expert LLM, in accordance with an embodiment of this disclosure. In some examples, part(s) of process flow 700 can be implemented by part(s) of system architecture 100 to facilitate a system-specific and query-specific expert LLM. In some examples, one or more embodiments of process flow 700 can be implemented by system architecture 100, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of process flow 600 of FIG. 6, process flow 800 of FIG. 8, process flow 900 of FIG. 9, and/or process flow 1000 of FIG. 10.

Process flow 700 begins with 702, and moves to operation 704.

In some examples where process flow 700 is implemented in conjunction with process flow 600 of FIG. 6, the summary is a first summary.

Operation 704 depicts inputting a fourth context to the large language model to produce a fourth output, wherein the fourth context comprises an updated description of the computing system relative to the description of the computing system, and wherein the fourth output comprises a second summary of the computing system different from the first summary. That is, when a domain or computing system changes, a new summary can be generated that reflects the new and/or modified components and/or behaviors.

After operation 704, process flow 700 moves to operation 706.

Operation 706 depicts producing results based on the second summary. That is, this new summary of the updated computing system can be used for processing queries.

After operation 706, process flow 700 moves to 708, where process flow 700 ends.

FIG. 8 illustrates another example process flow 800 that can facilitate a system-specific and query-specific expert LLM, in accordance with an embodiment of this disclosure. In some examples, part(s) of process flow 800 can be implemented by part(s) of system architecture 100 to facilitate a system-specific and query-specific expert LLM. In some examples, one or more embodiments of process flow 800 can be implemented by system architecture 100, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of process flow 600 of FIG. 6, process flow 700 of FIG. 7, process flow 900 of FIG. 9, and/or process flow 1000 of FIG. 10.

Process flow 800 begins with 802, and moves to operation 804.

Operation 804 depicts inputting a first context to a large language model to produce a first output, wherein the first context comprises a description of computer equipment, and wherein the first output comprises a summary of the computer equipment. In some examples, operation 804 can be implemented in a similar manner as operation 604 of FIG. 6.

In some examples, the summary is re-used for additional queries, independently of regenerating the summary with the large language model. In some examples, the summary is re-used for respective additional queries based on respective user input corresponding to respective multiple users. That is, the summary can be generated once, using the LLM, before users start working with the domain-specific-system. The summary can then be used for subsequent queries about the domain-specific-system, without being regenerated.

After operation 804, process flow 800 moves to operation 806.

Operation 806 depicts identifying examples from a group of examples stored in a database based on an input document and a query, wherein respective examples of the group of examples identify respective input queries and respective answers corresponding to the respective input queries. In some examples, operation 806 can be implemented in a similar manner as operation 606 of FIG. 6.

After operation 806, process flow 800 moves to operation 808.

Operation 808 depicts inputting a second context to the large language model to produce a second output, wherein the second context comprises the summary, at least two of the examples, the input document, and the query. In some examples, 808 can be implemented in a similar manner as operation 608 of FIG. 6.

In some examples, a number of examples of the at least two of the examples is based on an upper limit on size of the second context. In some examples, respective examples are first respective examples, and second respective examples of the at least two of the examples satisfy a top ranking criterion relative to the examples.

That is, top ranked examples found in operation 806 can be determined. In some examples, this can comprise as many examples as the context can hold, together with the input document and the summary. As the context gets bigger, it can become easier to provide more examples in the context and the ranking (of examples) can become less critical for the end-result.

After operation 808, process flow 800 moves to operation 810.

Operation 810 depicts inputting a third context to the large language model to produce a third output, wherein the third context comprises the summary, the at least two of the examples, the second output, and first user input data indicative of a refinement query. In some examples, operation 810 can be implemented in a similar manner as operation 610 of FIG. 6.

After operation 810, process flow 800 moves to operation 812.

Operation 812 depicts updating a process of the identifying of the examples from the database based on second user input data indicative of a grade of a quality of the third output. In some examples, operation 812 can be implemented in a similar manner as operation 612 of FIG. 6.

After operation 812, process flow 800 moves to 814, where process flow 800 ends.

FIG. 9 illustrates another example process flow 900 that can facilitate a system-specific and query-specific expert LLM, in accordance with an embodiment of this disclosure. In some examples, part(s) of process flow 900 can be implemented by part(s) of system architecture 100 to facilitate a system-specific and query-specific expert LLM. In some examples, one or more embodiments of process flow 900 can be implemented by system architecture 100, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of process flow 600 of FIG. 6, process flow 700 of FIG. 7, process flow 800 of FIG. 8, and/or process flow 1000 of FIG. 10.

Process flow 900 begins with 902, and moves to operation 904.

Operation 904 depicts inputting a context to the large language model to produce an output, wherein the context comprises a refinement query.

After operation 904, process flow 900 moves to operation 906.

Operation 906 depicts determining whether there is an additional refinement query. Where in operation 906 it is determined that there is an additional refinement query, process flow 900 returns to operation 904. Instead, where in operation 906 it is determined that there is not an additional refinement query, process flow 900 moves to 908, where process flow 900 ends.

FIG. 10 illustrates another example process flow 1000 that can facilitate a system-specific and query-specific expert LLM, in accordance with an embodiment of this disclosure. In some examples, part(s) of process flow 1000 can be implemented by part(s) of system architecture 100 to facilitate a system-specific and query-specific expert LLM. In some examples, one or more embodiments of process flow 1000 can be implemented by system architecture 100, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of process flow 600 of FIG. 6, process flow 700 of FIG. 7, process flow 800 of FIG. 8, and/or process flow 900 of FIG. 9.

Process flow 1000 begins with 1002, and moves to operation 1004.

Operation 1004 depicts inputting a first context to a large language model to obtain a first output, wherein the first context comprises a description of a second computer system, and wherein the first output comprises a summary of the second computer system. In some examples, operation 1004 can be implemented in a similar manner as operation 604 of FIG. 6.

In some examples, the summary of the second computer system and the at least some of the examples comprise a prefix to the second context. That is, a prompt prefix can comprise system-specific context and a curated array of input-query-and-answer examples. This prompt prefix can be inserted to each new query's prompt before the requested query and input document. The system can help build this prompt prefix, use it, and refine it, as users add new generated content to the system.

After operation 1004, process flow 1000 moves to operation 1006.

Operation 1006 depicts identifying examples from a group of examples stored via a database based on an input document and a query, wherein respective examples of the group of examples identify respective input queries and corresponding respective answers. In some examples, operation 1006 can be implemented in a similar manner as operation 606 of FIG. 6.

In some examples, the respective input queries of the respective examples comprise respective prompt queries and respective input documents. In some examples, the respective input queries omit the summary and any examples that correspond to the input queries. In some examples, the database stores, along with the respective examples, respective vectorized keywords of the respective input queries, the respective input documents, and the corresponding respective answers. That is, the database (e.g., Q&A DB 402 of FIG. 2) can store a prompt query and document input without the prefix of the system description and prior examples. The database can also store vectorized keywords of the query, input, and answer.

In some examples, the examples identified from the group of examples satisfy a relevance criterion relative to a vectorization of the input document and the query. That is, using vectorized keywords in a database, relevant examples can be graded against an extracted document, query keywords, and context.

After operation 1006, process flow 1000 moves to operation 1008.

Operation 1008 depicts inputting a second context to the large language model to obtain a second output, wherein the second context comprises the summary, at least some of the examples, the input document, and the query. In some examples, operation 1008 can be implemented in a similar manner as operation 608 of FIG. 6.

After operation 1008, process flow 1000 moves to operation 1010.

Operation 1010 depicts updating a process used for the identifying of the examples from the database based on user input data indicative of a grade of a quality of the second output. In some examples, operation 1010 can be implemented in a similar manner as operation 612 of FIG. 6.

After operation 1010, process flow 1000 moves to 1012, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of computer system 102 and/or user computer 106 of FIG. 1.

In some examples, computing environment 1100 can implement one or more embodiments of the process flows of FIGS. 6-10 to facilitate a system-specific and query-specific expert LLM.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1116 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
inputting a first context to a large language model to produce a first output, wherein the first context comprises a description of a first computing system other than the system and a prompt to summarize the description, and wherein the first output comprises a summary of the first computing system;
identifying examples from a group of examples stored in a database based on a vectorization of an input document and a query, wherein respective examples of the group of examples identify respective input queries and respective answers corresponding to the respective input queries, and wherein at least one example of the group of examples relates to a second computing system other than the first computing system or the system;
inputting a second context to the large language model to produce a second output, wherein the second context comprises the summary of the first computing system, at least some of the examples, the input document, and the query, and wherein the second output comprises a response corresponding to the second context;
inputting a third context to the large language model to produce a third output, wherein the third context comprises the summary of the first computing system, the at least some of the examples, the second output, and first user input data indicative of a refinement query; and
updating a process applicable to the identifying of the examples from the database based on second user input data indicative of a grade of a quality of the third output.

2. The system of claim 1, wherein a first character length of the summary of the first computing system is shorter than a second character length of the description of the first computing system.

3. The system of claim 1, wherein a character length of the summary of the first computing system is based on a maximum character length of a prefix to the large language model.

4. The system of claim 1, wherein the description of the first computing system comprises a first identification of a purpose of the first computing system, a second identification of a first functionality of the first computing system, or a third identification of a second functionality of components of the first computing system.

5. The system of claim 1, wherein the summary is a first summary, wherein the operations further comprise:
inputting a fourth context to the large language model to produce a fourth output, wherein the fourth context comprises an updated description of the first computing system relative to the description of the first computing system, and wherein the fourth output comprises a second summary of the first computing system different from the first summary.

6. The system of claim 1, wherein the vectorization of the input document and the query is performed based on a binary term frequency process or a bag of words term frequency process.

7. The system of claim 1, wherein the respective examples comprise respective scores, wherein the respective scores indicate respective quality of the respective answers, and wherein the identifying of the examples is performed based on the respective scores.

8. The system of claim 7, wherein the respective examples comprise respective scores, wherein the identifying of the examples is performed based on third user input data, and wherein the third user input data is indicative of a weighting of answer quality relative to concept closeness.

9. A method, comprising:
inputting, by a system comprising at least one processor, a first context to a large language model to produce a first output, wherein the first context comprises a description of computer equipment, and wherein the first output comprises a summary of the computer equipment;
identifying, by the system, examples from a group of examples stored in a database based on an input document and a query, wherein respective examples of the group of examples identify respective input queries and respective answers corresponding to the respective input queries;
inputting, by the system, a second context to the large language model to produce a second output, wherein the second context comprises the summary, at least two of the examples, the input document, and the query;
inputting, by the system, a third context to the large language model to produce a third output, wherein the third context comprises the summary, the at least two of the examples, the second output, and first user input data indicative of a refinement query; and
updating, by the system, a process of the identifying of the examples from the database based on second user input data indicative of a grade of a quality of the third output.

10. The method of claim 9, wherein the inputting of the third context to the large language model to produce the third output comprises:
performing at least one iteration of inputting respective contexts to the large language model to produce respective outputs, wherein the respective contexts comprise respective different refinement queries.

11. The method of claim 9, wherein a number of examples of the at least two of the examples is based on an upper limit on size of the second context.

12. The method of claim 11, wherein the respective examples are first respective examples, and wherein second respective examples of the at least two of the examples satisfy a top ranking criterion relative to the examples.

13. The method of claim 9, wherein the summary is re-used for additional queries, independently of regenerating the summary with the large language model.

14. The method of claim 9, wherein the summary is re-used for respective additional queries based on respective user input corresponding to respective multiple users.

15. A non-transitory computer-readable medium comprising instructions that, in response to execution, cause a first computer system comprising at least one processor to perform operations, comprising:
inputting a first context to a large language model to obtain a first output, wherein the first context comprises a description of a second computer system, and wherein the first output comprises a summary of the second computer system;
identifying examples from a group of examples stored via a database based on an input document and a query, wherein respective examples of the group of examples identify respective input queries and corresponding respective answers;
inputting a second context to the large language model to obtain a second output, wherein the second context comprises the summary, at least some of the examples, the input document, and the query; and
updating a process used for the identifying of the examples from the database based on user input data indicative of a grade of a quality of the second output.

16. The non-transitory computer-readable medium of claim 15, wherein the summary of the second computer system and the at least some of the examples comprise a prefix to the second context.

17. The non-transitory computer-readable medium of claim 15, wherein the examples identified from the group of examples satisfy a relevance criterion relative to a vectorization of the input document and the query.

18. The non-transitory computer-readable medium of claim 15, wherein the respective input queries of the respective examples comprise respective prompt queries and respective input documents.

19. The non-transitory computer-readable medium of claim 18, wherein the respective input queries omit the summary and any examples that correspond to the input queries.

20. The non-transitory computer-readable medium of claim 15, wherein the database stores, along with the respective examples, respective vectorized keywords of the respective input queries, the respective input documents, and the corresponding respective answers.
